(19) United States
(12) Patent Application Publication
(10) Pub. No.: US 2003/0188135 A1
(43) Pub. Date: Oct. 2, 2003

(54) Addressing modes and/or instructions and/or operating modes for on-the-fly, precision adjustment of packed data

(75) Inventor: Gad Sheaffer, Haifa (IL)

Correspondence Address: KENYON & KENYON, 1500 K STREET, N.W., SUITE 700, WASHINGTON, DC, 20005, US

(73) Assignee: INTEL CORPORATION

(21) Appl. No.: 10/107,260

(22) Filed: Mar. 28, 2002

(51) Int. Cl. G06F 9/00

(52) U.S. Cl. 712/221

(57) ABSTRACT

The present invention relates to a method and system for on-the-fly precision adjustment of packed data. Specifically, on-the-fly precision adjustment of packed data includes operating on data that may be either packed or unpacked data. The method and system also may store at least one packed or unpacked result from the operated on data. In accordance with an embodiment of the present invention, the method includes decoding an instruction, determining the instruction is to be executed using on-the-fly precision adjustment of packed data, executing the instruction using on-the-fly precision adjustment of packed data, and outputting at least one result from the executed instruction.

### FIELD OF THE INVENTION

The present invention relates to processor architectures and instruction sets, and in particular, to processor architectures with instruction sets which provide new addressing modes and/or instructions and/or operating modes for on-the-fly, precision adjustment of packed data.

### BACKGROUND

Processors today are operating on data types that are a multiple of 8 bits, such as 8, 16 and 32 bits. Fixed function hardware can be designed to the lowest possible precision, which, can achieve a 2-fold benefit over programmable cores, since the number of gates in the execution units is smaller and the memory bandwidth for storing and loading the data is smaller. However, with new process technology, the number of gates required for execution is becoming less critical, and the impact of memory bandwidth is becoming more acute as the speed of memories lag further and further behind the speed of the CPU.

Instructions and/or mechanisms to enable conserving memory bandwidth at the same level as fixed function hardware would be beneficial.

### BRIEF DESCRIPTION OF THE DRAWINGS

FIG. 1 is a block diagram of a computer system that includes an architectural state including one or more processors, registers and memory, in accordance with an embodiment of the present invention.

FIG. 2 is a top-level flow diagram of a method for providing on-the-fly, precision adjustment of packed data in a processor, in accordance with an embodiment of the present invention.

FIG. 3 is a detailed flow diagram of a method for providing on-the-fly, precision adjustment of packed data instructions in a processor, in accordance with an embodiment of the present invention.

FIG. 4 is a detailed flow diagram of a method for providing on-the-fly, precision adjustment of packed data addressing mode instructions in a processor, in accordance with an embodiment of the present invention.

FIG. 5 is a detailed flow diagram of a method for providing on-the-fly, precision adjustment of packed data modes in a processor, in accordance with an embodiment of the present invention.

### DETAILED DESCRIPTION

In accordance with an embodiment of the present invention, on-the-fly, precision adjustment of packed data instructions may be implemented to expand (unpack)/pack data. It should be understood that the instructions also may be defined to unpack/pack both high and low precision data.

In accordance with an embodiment of the present invention, on-the-fly, precision adjustment of packed data instructions may be implemented as an unpacking instruction to expand (unpack) a packed stream of 8 to 15 bit data into packed 16-bit and/or larger data types. It should be understood that the unpacking instruction also may be defined to expand lower precision data, such as, for example, 3 to 7 bit data, into packed bytes and/or larger data types, or 17 to 31 bit data into packed 32-bit and/or larger data types.

The unpacking instruction may use one or more UnPack Registers (UPR). Each UPR has a number of fields, which, may be defined, for example, as:

| | | |
|---|---|---|
| UPR.data | := | A N-bit field used as a staging area, where N=64,128, |
| | | etc. |
| UPR.counter | := | The number of valid bits in UPR. |
| UPR.size | := | The packed data precision. |
| UPR.zero | := | Zero extend when set. Default is sign extension. |

It should be understood that the above defined UPR fields are merely illustrative of the concept of the present invention and may vary with the precision of the packed data.

Since the ratio between the data entering and exiting the UPR is variable, the unpacking instruction may be implemented in at least three different ways, for example, two that add data to the UPR register and one that does not add data to the UPR register.

The impact of the on-the-fly, precision adjustment of packed data unpacking instructions on overall performance can be significant. For example, in accordance with an embodiment of the present invention, the unpacking instruction may enable a significant speedup of applications using the instruction, for example, applications for modems, speech and video. This is possible since the unpacking instruction, in accordance with an embodiment of the present invention may effectively replace a sequence of regular instructions that would have been required to perform the same operation. In addition, when used as a mode and/or addressing mode, the unpacking instruction overhead vanishes altogether.

In accordance with an embodiment of the present invention, on-the-fly, precision adjustment of packed data instructions may be implemented as a packing instruction to convert packed, continuous data of any size into a packed, continuous stream of any size data.

The packing instruction may use one or more PAck Registers (PAR). Each PAR has a number of fields, which, for 16-bit data, may be defined as:

| | | |
|---|---|---|
| PAR.data | := | A N-bit field used as a staging area. |
| PAR.counter | := | The number of valid bits in PAR. |
| PAR.size | := | Packed data size. |
| PAR.shift | := | The number of bits to shift right in order to scale the |
| | | data being precision adjusted. |
| PAR.sat | := | Zero extend when set. Default is sign extension. |

It should be understood that the above defined PAR fields are merely illustrative of the concept of the present invention and may vary with the size of the data to be packed.

Since the ratio between the data entering and exiting the PAR is variable, the packing instruction may be implemented in at least three different ways, for example, two that remove data from the PAR register and one that does not remove data from the PAR register.

As was the case with the unpacking instructions, the impact of the on-the-fly, precision adjustment of packed data packing instructions on overall performance can be significant. For example, in accordance with an embodiment of the present invention, the packing instruction may enable a significant speedup of applications using the instruction, for example, applications for modems, speech and video. This is possible since the packing instruction, in accordance with an embodiment of the present invention, may effectively replace a sequence of regular instructions that would have been required to perform the same operation. In addition, when used as a mode or an addressing mode, the packing instruction overhead vanishes altogether.

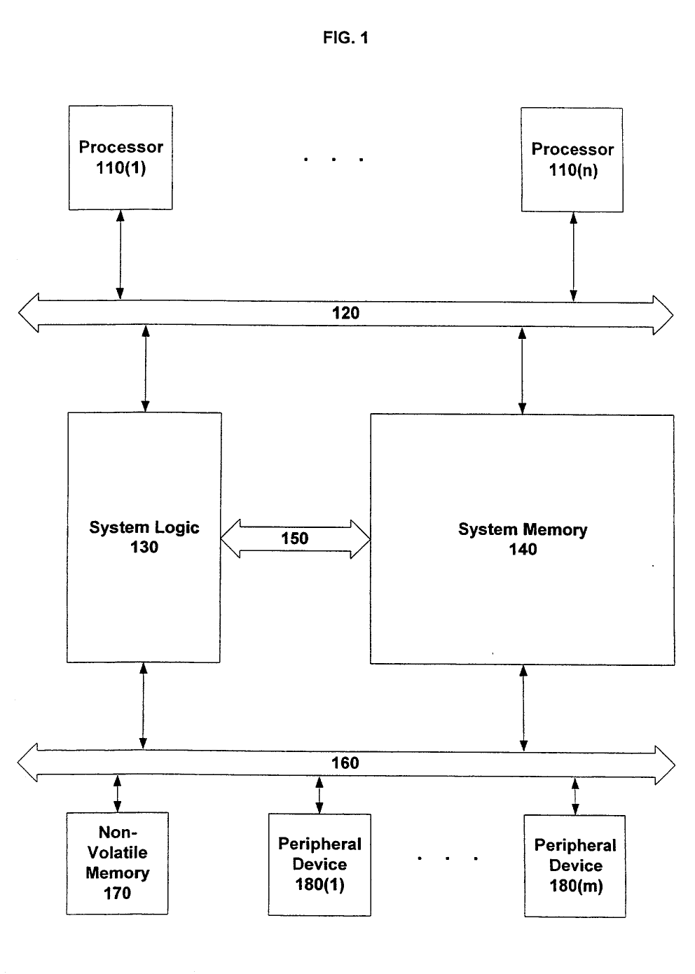

FIG. 1 is a block diagram of a computer system, which includes an architectural state, including one or more processors, registers and memory, in accordance with an embodiment of the present invention. In FIG. 1, a computer system 100 may include one or more processors 110(1)-110(n) coupled to a processor bus 120, which may be coupled to a system logic 130. Each of the one or more processors 110(1)-110(n) may be N-bit processors and may include a decoder (not shown) and one or more N-bit registers (not shown). System logic 130 may be coupled to a system memory 140 through a bus 150 and coupled to a non-volatile memory 170 and one or more peripheral devices 180(1)-180(m) through a peripheral bus 160. Peripheral bus 160 may represent, for example, one or more Peripheral Component Interconnect (PCI) buses, PCI Special Interest Group (SIG) PCI Local Bus Specification, Revision 2.2, published Dec. 18, 1998; industry standard architecture (ISA) buses; Extended ISA (EISA) buses, BCPR Services Inc. EISA Specification, Version 3.12, 1992, published 1992; universal serial bus (USB), USB Specification, Version 1.1, published Sep. 23, 1998; and comparable peripheral buses. Non-volatile memory 170 may be a static memory device such as a read only memory (ROM) or a flash memory. Peripheral devices 180(1)-180(m) may include, for example, a keyboard; a mouse or other pointing devices; mass storage devices such as hard disk drives, compact disc (CD) drives, optical disks, and digital video disc (DVD) drives; displays and the like.

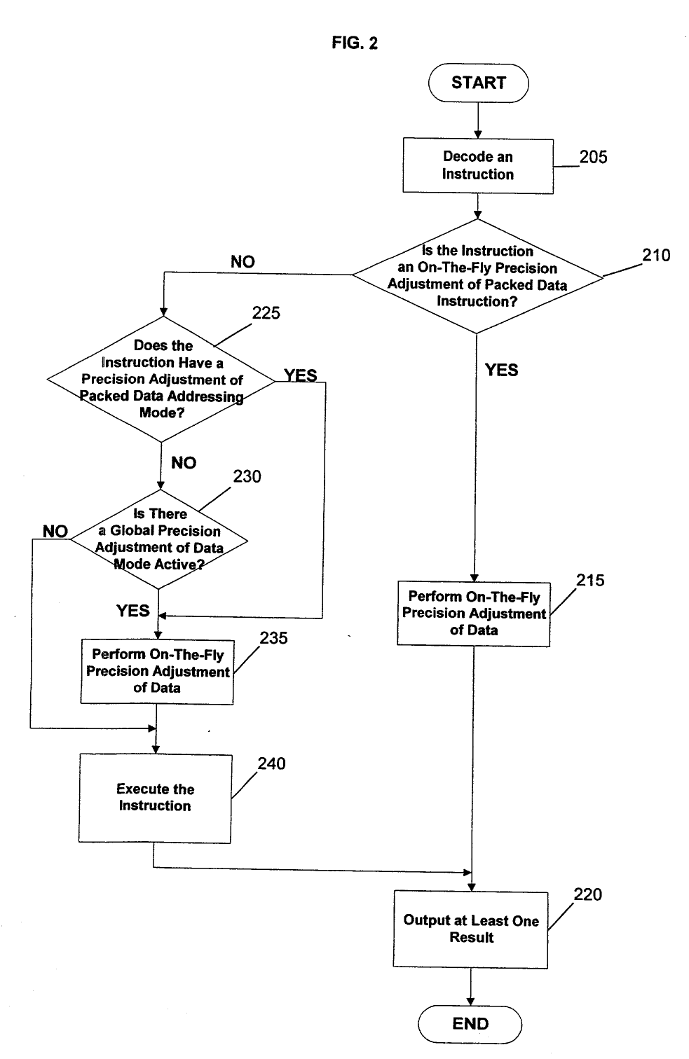

FIG. 2 is a top-level flow diagram of a method for providing on-the-fly, precision adjustment of packed data in a processor, in accordance with an embodiment of the present invention. In FIG. 2, an instruction may be decoded 205. Whether the instruction is an on-the-fly precision adjustment instruction may be determined 210. If the instruction is an on-the-fly, precision adjustment of data instruction, then on-the-fly, precision adjustment of data in the instruction may be performed 215. At least one result from the adjusted data may be output 220.

If the instruction is determined 210 not to be an on-the-fly, precision adjustment instruction, whether the instruction has a precision adjustment addressing mode may be determined 225. If the instruction has a precision adjustment addressing mode, then on-the-fly, precision adjustment of data in the instruction may be performed 235. The instruction may execute 240 as a precision adjustment addressing mode instruction and at least one result may be output 220. If the instruction is determined 225 not to have a precision adjustment addressing mode, whether a global precision adjustment of data mode is active may be determined 230. If the global precision adjustment of data mode is determined 230 to be active, then on-the-fly, precision adjustment of data in the instruction may be performed 235. The instruction may execute 240 in the precision adjustment of data mode and at least one result may be output 220. If the precision adjustment of data mode is determined 230 not to be active, the instruction may execute 240 as decoded, that is, without precision adjustment of data, and at least one result may be output 220.

In accordance with an embodiment of the present invention, the method of FIG. 2 may be performed in a one or more cycles.

In accordance with an embodiment of the present invention, the on-the-fly, precision adjustment of data instruction may be implemented as an unpacking instruction to unpack one or more unpack registers. Specifically, the generic syntax of the unpacking instruction, alternatively, may be represented by any of the following three instruction formats:

| | |
|---|---|
| destR0, destR1 = unpack(srcA, srcB) | [UPR1][shift], |
| destR0, destR1 = unpack(srcA) | [UPR1][shift], |
| destR0, destR1 = unpack( ) | [UPR1][shift], |

where the square brackets ([ ]) denote the optional instruction parameters that are not required for execution of the instruction; destR0 and destR1 may be destination registers; srcA and srcB may be new data operands; UPR1 may be an unpack register that if included causes the instruction to use the UPR1 register, however, if UPR1 is not included, the instruction uses default register UPR0, and shift may be an optional variable that is used to shift whichever register, UPR0 or UPR1, is used.

Setting the shift option value to TRUE may cause the unpacking instruction to shift whichever unpack register is being used to the right by 4 times the number of bits being unpacked, where the size of the data may range from 8 to 15 bits.

In accordance with an embodiment of the present invention, the unpacking instructions described below may be, generally, completely executed over a single processor clock cycle. However, it should be clearly understood that the unpacking instructions also may be implemented to be executed over a two (2) or more clock cycles, although this may adversely affect the efficiency of the instruction.

In accordance with an embodiment of the present invention, the functionality of the unpacking instruction may be defined by the following C-style pseudo-code example:

Extract and sign/zero-extend to 16 bits

out00 = sign/zero-extend UPRᵢ.data[UPRᵢ.size-1:0]
out01 = sign/zero-extend UPRᵢ.data[2 * UPRᵢ.size-1:UPRᵢ.size]
out10 = sign/zero-extend UPRᵢ.data[3 * UPRᵢ.size-1:2 * UPRᵢ.size]
out11 = sign/zero-extend UPRᵢ.data[4 * UPRᵢ.size-1:3 * UPRᵢ.size]

Conditionally shift UPR

if shift
{

Shift UPRᵢ. right by size * 4
UPRᵢ.counter −= size * 4

}

Store new data into UPR

If (srcA defined AND UPRᵢ.counter < 33)
{

UPRᵢ.data[UPRᵢ.counter + 31, UPRᵢ.counter] = srcA
UPRᵢ.counter += 32

}
If(srcB defined AND UPRᵢ.counter < 33)
{

UPRᵢ.data[UPRᵢ.counter + 31, UPRᵢ.counter] = srcB
UPRᵢ.counter += 32

}
destR0 = (out01, out00)
destR1 = (out11, out10)

Similarly, in accordance with an embodiment of the present invention, the on-the-fly, precision adjustment of data instruction also may be implemented as a packing instruction to pack, for example, 16-bit data. Specifically, the generic syntax of the on-the-fly packing instruction, alternatively, may be represented by any of the following:

| | | | |
|---|---|---|---|
| dest0, dest1 | = | pack(srcA, srcB) | [PAR1], |
| dest0 | = | pack(srcA, srcB) | [PAR1], |
| | = | pack(srcA, srcB) | [PAR1], |

where dest0 and dest1 are destination registers; srcA and srcB are new data operands; PAR1 is a pack register that if included causes the instruction to use the PAR1 register, however, if PAR1 is not included, the instruction uses default register PAR0.

In accordance with an embodiment of the present invention, the instructions described below may be, generally, completely executed over a single processor clock cycle. However, it should be clearly understood that the instructions also may be implemented to be executed over two (2) or more clock cycles, although this may adversely affect the efficiency of the instruction.

In accordance with an embodiment of the present invention, the functionality of the on-the-fly packing instruction may be defined by the following C-style pseudo-code example:

Remove items from PARi

If (dest1 defined AND PARᵢ.counter > 31)
{

dest1 = PARᵢ.data[PARᵢ.counter + 31, PARᵢ.counter ]

PARᵢ.counter −= 32

}
If(dest0 defined AND PARᵢ.counter > 31)
{

dest0 = PARᵢ.data[PARᵢ.counter + 31, PARᵢ.counter ]
PARᵢ.counter −= 32

}

Shift PAR

Shift PARᵢ.data left by size * 4

Extract and saturate to size the input values and store into PAR

PARᵢ.data [PARᵢ.size-1 : 0] = sat2size(srcA.1 >>

PARᵢ.shift)

PARᵢ.data [2 * PARᵢ.size-1 : PARᵢ.size] = sat2size(srcA.h >>

PARᵢ.shift)

PARᵢ.data [3 * PARᵢ.size-1 : 2 * PARᵢ.size] = sat2size(srcB.1 >>

PARᵢ.shift)

PARᵢ.data [4 * PARᵢ.size-1 : 3 * PARᵢ.size] = sat2size(srcB.h >>

PARᵢ.shift)

Update the number of valid bits

PARᵢ.counter += size * 4

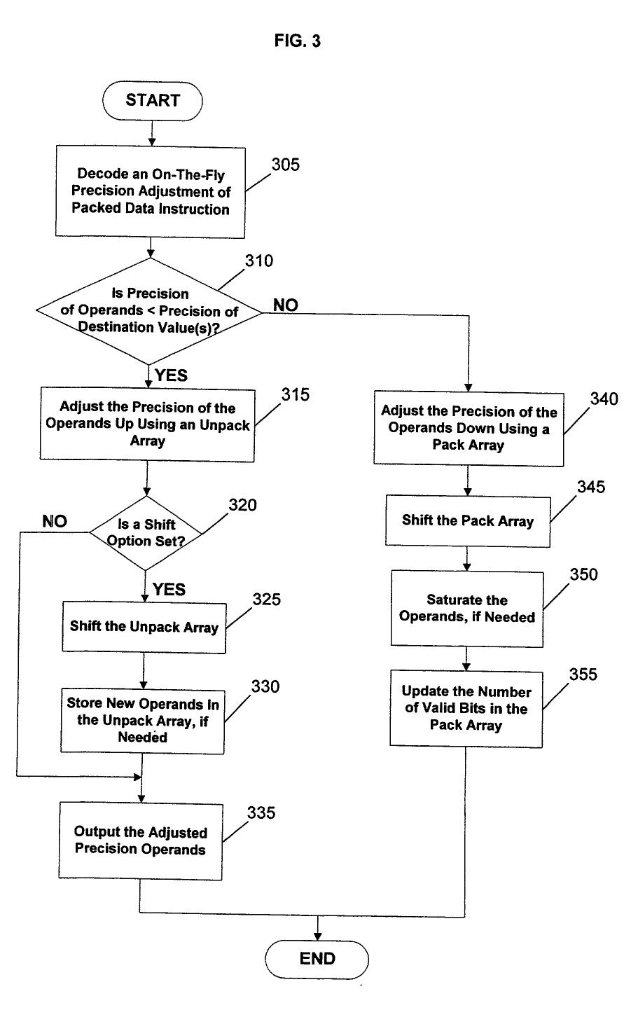

FIG. 3 is a detailed flow diagram of a method for providing on-the-fly, precision adjustment of packed data instructions in a processor, in accordance with an embodiment of the present invention. In FIG. 3, an instruction may be decoded 305 as an on-the-fly, precision adjustment of packed data instruction. Whether the precision of operands in the instruction are less than the precision of destination values may be determined 310. If the operand precision is determined 310 to be less, the precision of the operands may be adjusted 315 up using an unpack array. Whether a shift option is set may be determined 320. If the shift option is determined 320 to be set, the unpack array may be shifted 325 by a predetermined number of bits and new operands may be stored 330 in the unpack array, if the new operands are included in the instruction. The adjusted precision operands may be output 335 and the method may terminate. If the shift option is determined 320 not to be set, the adjusted precision operands may be output 335 and the method may terminate.

In FIG.3, if the operand precision is determined 310 not to be less, the precision of the operands may be adjusted 340 down using a pack array. The pack array may be shifted 345 by a predetermined number of bits and, if necessary, the operands may be saturated 350. The number of valid bits in the pack array may be updated 355 and the method may terminate.

The method of FIG. 3 may be implemented in one or more separate instructions.

In accordance with another embodiment of the present invention, the functionality of the on-the-fly precision adjustment of packed data instruction may be implemented as an addressing mode unpacking instruction so that one of the UPR registers may act as an unpack modifier to consume packed odd-sized data. This addressing mode unpacking instruction may be defined by the following C-style pseudo-code example:

destR=srcA+srcB UPR0

Which is equivalent to:

OPA, OPB=unpack(srcA, srcB) UPR0

destR=OPA+OPB

Where OPA and OPB may be temporary data operands for holding the unpacked values from the original srcA and srcB operands.

Similarly, in accordance with another embodiment of the present invention, the functionality of the on-the-fly, precision adjustment of packed data instruction may be implemented as an addressing mode so that one of the PAR registers may act as a pack modifier to produce odd-sized data. This instruction may be defined by the following C-style pseudo-code example:

dest=srcA+srcB PAR0

Which is equivalent to:

temp=srcA+srcB

dest=pack(temp) PAR0

Where temp may be a temporary value holding the unpacked result from the execution of the instruction.

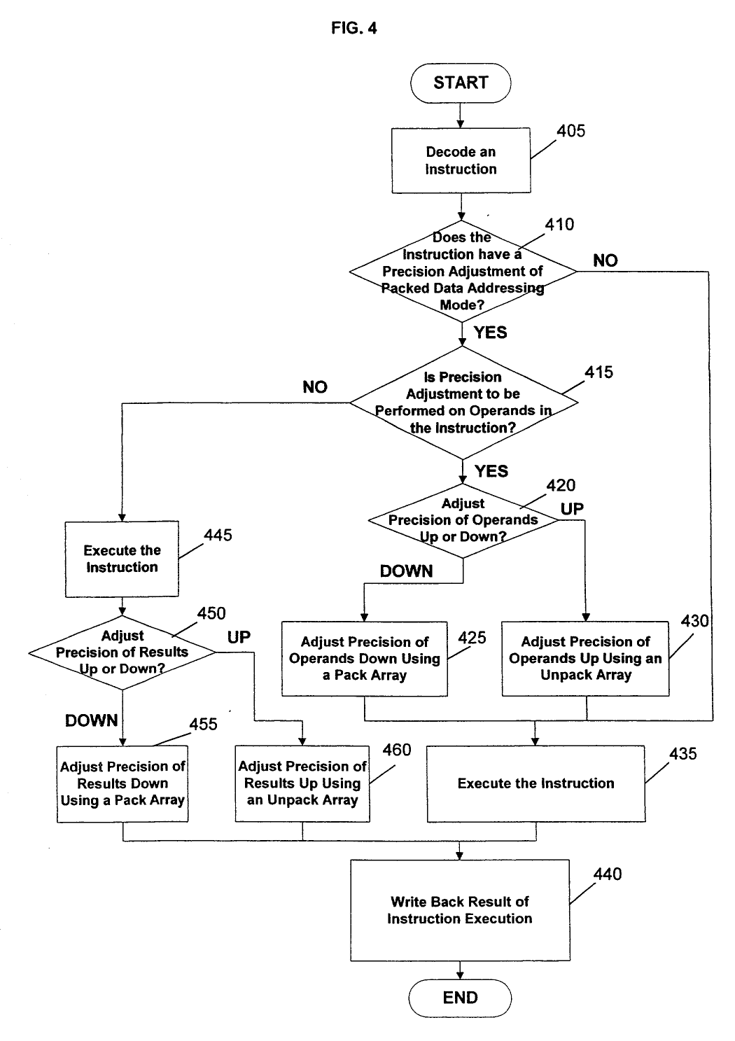

FIG. 4 is a detailed flow diagram of a method for providing on-the-fly, precision adjustment of packed data addressing mode instructions in a processor, in accordance with an embodiment of the present invention. In FIG. 4, an instruction may be decoded 405. Whether the instruction has a precision adjustment of packed data addressing mode may be determined 410. If the instruction is determined 410 to have the precision adjustment of packed data addressing mode, whether the precision adjustment is to be performed on operands in the instruction may be determined 415. If the precision adjustment is to be performed on the operands, whether the precision is to be adjusted up or down may be determined 420. If the precision is to be adjusted down, the precision of the operands may be adjusted 425 down using a pack array, in general, a pack register. If the precision is to be adjusted up, the precision of the operands may be adjusted 430 up using an unpack array, in general, an unpack register. Regardless of whether the precision of the operands are adjusted up or down, the instruction may be executed 435. A precision adjusted result of the execution 435 may be written back 440 and the method may terminate. Similarly, if the instruction is determined 410 not to have a precision adjustment of packed data addressing mode, the instruction may be executed 435 using the unadjusted operands. A result of the execution 435 may be written back 440 and the method may terminate.

In FIG. 4, if the precision adjustment is determined 415 not to be performed on the operands, the instruction may be executed 445 using the operands from the instruction. Whether the precision is to be adjusted up or down may be determined 450. If the precision is to be adjusted down, the precision of the result(s) may be adjusted 455 down, using the pack array, in general, the pack register. If the precision is to be adjusted up, the precision of the result(s) may be adjusted 460 up using the unpack array, in general, the unpack register. Regardless of whether the precision of the result(s) are adjusted up or down, a result may be written back 440 and the method may terminate.

The method of FIG. 4 may be implemented in one or more separate instructions.

In accordance with yet another embodiment of the present invention, the functionality of the on-the-fly, precision adjustment of packed data instruction may be implemented as an unpacking mode in which a processing core may associate a UPR register with each pipeline of the machine. This may have the effect that every instruction executing in a given pipeline, when the “unpack” mode is set, operates on unpacked data.

Similarly, in accordance with yet another embodiment of the present invention, the functionality of the on-the-fly, precision adjustment of packed data instruction may be implemented as a mode in which a processing core may associate a PAR register with each pipeline of the machine. This may have the effect that every instruction executing in a given pipeline, when the “pack” mode is set, will produce packed data.

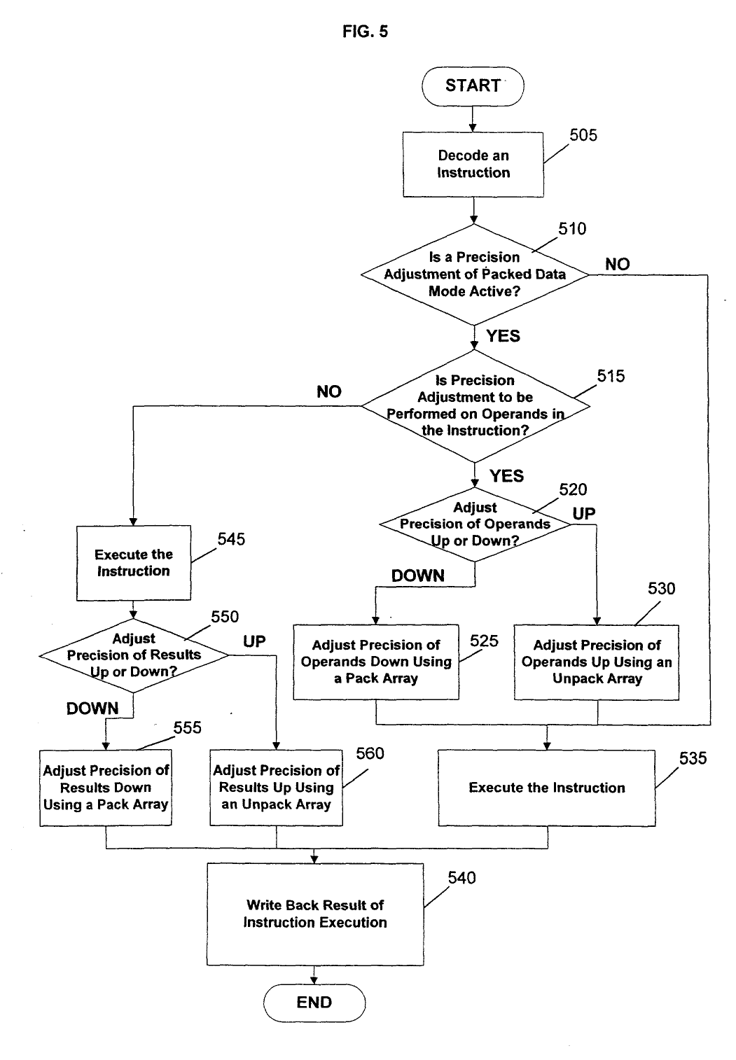

FIG. 5 is a detailed flow diagram of a method for providing on-the-fly, precision adjustment of packed data mode in a processor, in accordance with an embodiment of the present invention. In FIG. 5, an instruction may be decoded 505. Whether a precision adjustment of packed data mode is active may be determined 510. If the precision adjustment of packed data mode is active, whether the precision adjustment is to be performed on the operands in the instruction may be determined 515. If the precision adjustment is to be performed on the operands, whether the precision is to be adjusted up or down may be determined 520. If the precision is to be adjusted down, the precision of the operands may be adjusted 525 down using the pack array, in general, the pack register. If the precision is to be adjusted up, the precision of the operands may be adjusted 530 up using the unpack array, in general, the unpack register. Regardless of whether the precision of the operands are adjusted up or down, the instruction may be executed 535. A precision adjusted result of the execution 535 may be written back 540 and the method may terminate. Similarly, if the instruction is determined 510 not to have a precision adjustment of packed data addressing mode, the instruction may be executed 535 using the unadjusted operands. A result of the execution 535 may be written back 540 and the method may terminate.

The method of FIG. 5 may be implemented in on or In FIG. 5, if the precision adjustment is determined 515 not to be performed on the operands, the instruction may be executed 545 using the operands from the instruction. Whether the precision is to be adjusted up or down may be determined 550. If the precision is to be adjusted down, the precision of the result(s) may be adjusted 555 down using the pack array, in general, the pack register. If the precision is to be adjusted up, the precision of the result(s) may be adjusted 560 up using the unpack array, in general, the unpack register. Regardless of whether the precision of the result(s) are adjusted up or down, a result may be written back 540 and the method may terminate.

The method of FIG. 5 may be implemented in one or more separate instructions.

In accordance with an embodiment of the present invention, a method for providing on-the-fly precision adjustment of packed data a processor including decoding an instruction and determining the instruction is to be executed using on-the-fly precision adjustment of packed data. The method may further include executing the instruction using on-the-fly precision adjustment of packed data and outputting at least one result from the executed instruction.

In accordance with an embodiment of the present invention, a processor including a decoder to decode instructions and a circuit coupled to the decoder. The circuit in response to a decoded instruction to determine whether the decoded instruction is to be executed using on-the-fly precision adjustment of packed data; execute the decoded instruction using on-the-fly precision adjustment of packed data; and output at least one result from the executed instruction.

In accordance with an embodiment of the present invention, a computer system including a processor; and a machine-readable medium coupled to the processor in which is stored one or more instructions adapted to be executed by the processor. The instructions which, when executed, configure the processor to decode an instruction and determine whether the instruction is to be executed using on-the-fly precision adjustment of packed data. The instructions further configure the processor to execute the instruction using on-the-fly precision adjustment of packed data and output at least one result from the operated on data.

In accordance with an embodiment of the present invention, a machine-readable medium in which is stored one or more instructions adapted to be executed by a processor, the instructions which, when executed, configure the processor to decode an instruction and determine whether the instruction is to be executed using on-the-fly precision adjustment of packed data. The instructions further configure the processor to execute the instruction using on-the-fly precision adjustment of packed data and output at least one result from the operated on data.

While the embodiments described above relate mainly to 16-bit data on-the-fly, precision adjustment of data instruction embodiments, they are not intended to limit the scope or coverage of the present invention. In fact, the method described above can be implemented with different sized data types such as, for example, 8-bit, 16-bit, 32-bit, 64-bit and/or larger data.

It should, of course, be understood that while the present invention has been described mainly in terms of microprocessor-based and multiple microprocessor-based personal computer systems, those skilled in the art will recognize that the principles of the invention, as discussed herein, may be used advantageously with alternative embodiments involving other integrated processor chips and computer systems. Accordingly, all such implementations which fall within the spirit and scope of the appended claims will be embraced by the principles of the present invention.

What is claimed is:

1. A method for providing on-the-fly precision adjustment of packed data in a processor, the method comprising:
decoding an instruction;
determining said instruction is to be executed using on-the-fly precision adjustment of packed data;
executing said instruction using on-the-fly precision adjustment of packed data; and
outputting at least one result from said executed instruction.

2. The method as described in claim 1 wherein said decoding operation comprises:
decoding said instruction as on-the-fly precision adjustment of packed data unpacking instruction.

3. The method as described in claim 2 wherein said executing operation comprises:
adjusting the precision of an operand using an unpack array;
shifting said unpack array, if requested in said on-the-fly precision adjustment of packed data unpacking instruction; and
storing said operand in said unpack array.

4. The method as described in claim 3 wherein said adjusting the precision operation comprises:
extracting a first predetermined number of bits from said unpack array extending said first predetermined number of bits to 16 bits; and
setting a first output value equal to said extended first predetermined number of bits.

5. The method as defined in claim 4 wherein said extending operation comprises one of:
sign-extending said first predetermined number of bits to 16 bits; and
zero-extending said first predetermined number of bits to 16 bits.

6. The method as defined in claim 4 further comprising:
extracting a second predetermined number of bits from said unpack array;
extending said second predetermined number of bits to 16 bits;
setting a second output value equal to said second set of predetermined number of bits;
extracting a third predetermined number of bits from said unpack array;
extending said third predetermined number of bits to 16 bits;
setting a third output value equal to said third set of predetermined number of bits;
extracting a fourth predetermined number of bits from said unpack array;
extending said fourth predetermined number of bits to 16 bits; and
setting a fourth output value equal to said fourth set of predetermined number of bits.

7. The method as defined in claim 6 wherein each of said extending operations comprise one of:
sign-extending said first predetermined number of bits to 16 bits; and
zero-extending said first predetermined number of bits to 16 bits.

8. The method as defined in claim 3 wherein said shifting operation comprises:
determining said on-the-fly precision adjustment of packed data unpacking instruction requested said unpack array be shifted;
shifting said unpack array to the right by a number of bits equal to a number of bits in said operand; and
decrementing a valid bits counter by a value equal to said number of bits in said operand.

9. The method as defined in claim 3 wherein said adding operation comprises:
determining said operand is included in said on-the-fly precision adjustment of packed data instruction;
adding said operand to said unpack array; and
incrementing a valid bits counter by 32.

10. The method as defined in claim 9 further comprises:
determining a second operand is included in said on-the-fly precision adjustment of packed data instruction;
adding said second operand to said unpack array; and
incrementing said valid bits counter by 32.

11. The method as defined in claim 2 wherein said outputting operation comprises:
storing a first output value and a second output value in a first destination register; and
storing a third output value and a fourth output value in a second destination register.

12. The method as defined in claim 1 wherein said decoding operation comprises:
decoding said instruction as an on-the-fly precision adjustment of packed data packing instruction.

13. The method as defined in claim 12 wherein said executing operation comprises:
adjusting the precision of an operand using a pack array;
shifting said pack array; and
saturating said operand, if necessary.

14. The method as defined in claim 13 wherein said adjusting the precision operation comprises:
determining said on-the-fly precision adjustment of packed data packing data instruction includes at least one destination;
setting a first of said at least one destination equal to a first predetermined number of bits from said identified data; and
decrementing a valid bits counter by 32.

15. The method as defined in claim 13 wherein said shifting operation comprises:
shifting said pack array to the left by a number of bits equal to a number of bits in said operand.

16. The method as defined in claim 13 wherein said saturating operation comprises:
extracting a first predetermined number of bits from said operand;
saturating said first predetermined number of bits;
storing said saturated first predetermined number of bits in said pack array;
extracting a second predetermined number of bits;
saturating said second predetermined number of bits; and
storing said saturated second predetermined number of bits.

17. The method as defined in claim 16 wherein each of said storing operation occurs in said pack array at a predetermined location.

18. The method as defined in claim 16 wherein each of said saturating operations comprise:
extending said saturated predetermined number of bits to 16 bits.

19. The method as defined in claim 18 wherein said extending operation comprises one of:
sign-extending said saturated predetermined number of bits to 16 bits; and
zero-extending said saturated predetermined number of bits to 16 bits.

20. The method as defined in claim 16 wherein said storing operation comprises: incrementing a counter to indicate a number of valid bits in said operand.

21. A processor, said processor comprising:
a decoder to decode instructions;
a circuit coupled to said decoder, said circuit in response to a decoded instruction to determine whether said decoded instruction is to be executed using on-the-fly precision adjustment of packed data;
execute said decoded instruction using on-the-fly precision adjustment of packed data; and
output at least one result from said executed instruction.

22. The processor as defined in claim 21 wherein said decoded instruction is one of:
an on-the-fly precision adjustment of packed data unpacking instruction;
an on-the-fly precision adjustment of packed data packing instruction;
an on-the-fly precision adjustment of packed data addressing mode unpacking instruction;
an on-the-fly precision adjustment of packed data addressing mode packing instruction; and
an instruction, said instruction for execution in said processor where said processor has a mode set as one of
an unpack mode; and
a pack mode.

23. The processor as defined in claim 21 wherein said processor further comprises:
a register, said register acting as a function modifier to specify the function as one of an unpack operation and a pack operation.

24. A computer system, the computer system comprising:
a processor; and
a machine-readable medium coupled to the processor in which is stored one or more instructions adapted to be executed by the processor, the instructions which, when executed, configure the processor to
decode an instruction;
determine said instruction is to be executed using on-the-fly precision adjustment of packed data;
execute said instruction using on-the-fly precision adjustment of packed data; and
output at least one result from said operated on data.

25. The computer system as defined in claim 24 wherein said decoded instruction is one of:
an on-the-fly precision adjustment of packed data unpacking instruction;
an on-the-fly precision adjustment of packed data packing instruction;
an on-the-fly precision adjustment of packed data addressing mode unpacking instruction;
an on-the-fly precision adjustment of packed data addressing mode packing instruction; and
an instruction, said instruction for execution in said processor where said processor has a mode set as one of
an unpack mode; and
a pack mode.

26. The computer system as defined in claim 25 wherein said processor comprises:
a register, said register acting as a function modifier to specify the function as one of an unpack operation and a pack operation.

27. A machine-readable medium in which is stored one or more instructions adapted to be executed by a processor, the instruction which, when executed, configure the processor to:
decode and instruction;
determine said instruction is to be executed using on-the-fly precision adjustment of packed data;
execute said instruction using on-the-fly precision adjustment of packed data; and
output at least one result from said operated on data.

28. The machine-readable medium as defined In claim 27 wherein said decode operation configures the processor to decode said instruction as one of:
an on-the-fly precision adjustment of packed data unpacking instruction;
an on-the-fly precision adjustment of packed data packing instruction;
an on-the-fly precision adjustment of packed data addressing mode unpacking instruction;
an on-the-fly precision adjustment of packed data addressing mode packing instruction; and
an instruction, said instruction for execution in said processor where said processor has a mode set as one of
an unpack mode; and
a pack mode.

29. The machine-readable medium as defined in claim 28 wherein each of said on-the-fly precision adjustment of packed data addressing mode unpacking and packing instructions comprises:
a function modifier said function modifier to specify the function as one of an unpack operation and a pack operation.

30. The machine-readable medium as defined in claim 27 wherein said execute operation configures the processor to:
adjust the precision of an operand using an array.
